(19) United States
(12) Patent Application Publication
(10) Pub. No.: US 2003/0061682 A1
(43) Pub. Date: Apr. 3, 2003

(54) Cabinet Hinge

(76) Inventors: Wolfgang Muelller, Lustenau (AT); Markus Albrecht, Lustenau (AT); Remo Egger, Bregenz (AT); Holger Wenzel, Weibensberg (DE)

Correspondence Address: John M. Harrington, Kilpatrick Stockton LLP, 1001 West Fourth Street, Winsto-Salem, NC, 27101, US

(21) Appl. No.: 10/230,860

(22) Filed: Aug. 29, 2002

(30) Foreign Application Priority Data
Aug. 31, 2001 (EP) 01120957.4

(51) Int. Cl. E05D 7/04

(52) U.S. Cl. 16/238

(57) ABSTRACT

The invention concerns a cabinet hinge with a side adjusting device that connects directly or indirectly on a cabinet-side, has a single- or multi-part baseplate (1) holding a hinge arm that is connected jointed or linked or hinged with a door-side stop component so that by means of the side adjusting device, the hinge arm's position can be changed perpendicular to the baseplate, and, at the same time, results in a correction of the depth adjustment of the hinge arm. This correction of the depth adjustment, which can also be described as a gap or reveal equalization, is accomplished by a corresponding side adjusting screw; that is, correspondingly by operating or turning the side adjusting screw. The adjusting element achieves restrained and controlled guidance of the hinge arm during the adjustment.

The invention concerns a cabinet hinge with an adjusting device that connects directly or indirectly on a cabinet-side, has a single- or multi-part baseplate holding a hinge arm, according to the introductory or characterizing clause of the individual and independent patent claims.

In general various adjustments are possible with cabinet hinges.

So, one adjustment possibility is the adjustment of the hinge arm relative to the baseplate in the direction of the cabinet reveal or gap (that is, a side adjustment of the cabinet door). This adjustment is attained by the so-called side adjustment screw, which is held in a thread of the hinge arm and is held by its head in a recess of the baseplate. Depending on how the screw is turn, the hinge arm is lifted more or less from the baseplate, resulting in a lateral or side adjustment of the cabinet door.

Another adjustment that is possible concerns the depth adjustment of the hinge arm in which the cabinet door's distance from the front side of the cabinet is adjusted. The depth adjustment is achieved generally by means of a clamping screw, by which the hinge clip is fastened on the baseplate. The clamping screw projects through an elongated hole in the hinge arm; so the depth adjustment is attained by gliding along the elongated hole, so that the depth adjustment is determined by the length of the elongated hole.

A cabinet hinge of the above-described type is made known by, for example, document DE 29311793 U1.

The known adjustment device, however, has considerable disadvantages.

With reference to the side adjustment of the door, the hinge arm swings or swivels around an imaginary axis when the side adjusting screw is turned, causing an adjusting movement to take place along a circular arc. In this way, not only is the side or lateral position of the door adjusted, but an undesired change of the door's depth position also occurs, because the door's distance from the cabinet's front edge has been altered.

A hinge that also has the equalizing function of the depth position with a side adjustment is described in document DE 299 14 473 U1. At least one swinging or swiveling lever is provided, that swings or swivels when the side adjusting screw is turned and which is supported directly or indirectly by the hinge arm; whereby, the hinge arm is guided parallel to the baseplate when the reveal/gap adjustment screw is turned. The design/construction presented here, however, is very expensive to produce and manufacture.

Document 0 969 173 A2 makes known a cabinet hinge with a special swing-bearing system, in which adjusting the side adjusting device causes a corresponding gap or reveal equalization to take place, since the hinge arm is guided in a controlled and restrained manner.

The task of the invention is to present a cabinet hinge that has improved adjustment possibilities with gap/reveal equalization function, without excessive construction, design and production expenses being necessary.

The solution of this task follows by the characteristics and features in the individual and independent patent claims.

In a first embodiment of the invention, the side adjusting device has a hinge arm connected to the adjusting body or element, that is guided moveable on the slanted guide brackets of the bearing plate, is engaged by a side adjusting screw and, when the side adjusting screw is operated (turned), moves together with the hinge arm parallel to the guide.

The guide brackets are slanted (for example, at a 45° angle) and project up from the upper surface of the bearing plate. The adjusting body/element is inserted between the guide brackets. The adjusting body is basically prism-shaped and includes two slanted gliding surfaces that are parallel to each other and that always lie on the corresponding guide brackets.

Preferably, the adjusting body/element has two lateral pins that are opposite each other and are held in corresponding bore holes on the side shanks of the hinge arm.

When the side adjusting screw is turned, the adjusting body is moved with the connected hinge arm and the screw along the determined track set by the guide brackets.

In a second embodiment of the invention, it is provided that the side adjusting device is held in one of the bearing plates and is connected directly or indirectly by the side adjusting screw that has a head section and a thread section, so that the longitudinal middle axis of the thread section forms an angle with the longitudinal middle axis of the bearing plate, and that turning the side adjusting screw causes the hinge arm to move along the longitudinal middle axis of the thread section.

According to the invention, the head section is connected elastic, flexible or linked with the thread section, so that the middle longitudinal axis of the head section and the thread section run differently.

In order to increase the possible side adjustment lift, the thread section has left-hand thread on its lower area and right-hand thread on its upper area, so that the left-hand thread engages in a thread receptacle of the bearing plate and the right-hand thread engages through a thread receptacle of an adapter piece.

The adapter piece is connected securely with the hinge arm and takes it with it when the side adjusting screw is operated.

According to the invention, the side adjusting screw can, especially the connection between the head section and the thread section, be designed differently.

The head section can, according to a first embodiment, be connected by means of an elastic separator piece with the thread section.

The head section can, however, also have in the lower area a bomb-shaped hexagon that engages in a hexagonal opening of the thread section.

According to another embodiment, the head section has a shaft with several pins distributed on the perimeter. These pins are provided in order to engage laterally with the slots distributed around the perimeter of the thread section.

All connection forms between the head section and the thread section make it possible to operate the thread section in one of the head sections' various angle areas.

Preferably, the head section can be fixed revolvable in an opening of the hinge arm.

In a third embodiment of the invention, the side-adjusting device includes a side adjusting screw that has a lower thread section and an upper thread section. The lower thread section engages in a thread receptacle of the bearing plate and the upper thread section engages along the thread section's movable adjusting element that is connected with a kinematic adapter, which is held, able to swivel or swing, on a linkage bolt of the hinge arm and swings or swivels around an axis, depending on the position of the adjusting element.

According to this embodiment, the kinematic adapter swings, when the side adjusting screw is turned, in such a way that the angle, which is formed from the middle longitudinal axis of the baseplate and the kinematic adapter, remains constant. Therefore, the kinematic of the hinge linkage does not change when the side adjusting screw is utilized.

The thread sections can, preferably, have different inclinations or pitches so that the swinging or swiveling motion of the kinematic adapter can be determined by the side adjusting movement of the hinge arm.

As a driver for the kinematic adapter, the provided element has two oppositely placed pins that are held movable in corresponding elongated holes of the kinematic adapter.

So that the hinge arm swings smoothly and easily during an adjusting movement, a bomb-shaped bearing block can be provided between the hinge arm and the bearing plate in a distance from the side adjusting screw and is placed linear and movable on the bearing plate.

In a fourth embodiment of the invention, the side adjusting device has pivoted levers, which are held, able to swivel, on the hinge arm and whose lever arms on or in opposite to the baseplate's fixed parts of the hinge are guided, so when the side adjusting screw is operated, a restrained and controlled guidance of the hinge arm is provided.

The adjusting plate and a separator plate are provided as fixed parts to guide the pivoted levers.

Pins are always placed on the lever arms of the pivoted levers, that, on the one hand, are guided in a linear guidance of the adjusting plate and, on the other hand, are guided in a linear guidance of the separator plate so that an additional pin is always provided that is held, able to turn, in a bore hole of the hinge arm.

The pivoted levers in the hinge arm are, preferably, located fundamentally parallel to the side shanks of the hinge arm so that the guides of the adjusting plate and the guides of the separator plate run together at an angle—preferably an angle between 80° and 100°.

Subsequently, several embodiments of the invention are more closely described based on the drawing and figures. Additional features, characteristics, advantages and possible utilizations of the invention follow from the drawings and their descriptions.

Shown:

FIG. 1: a longitudinal section through a first embodiment of the invention-related cabinet hinge;

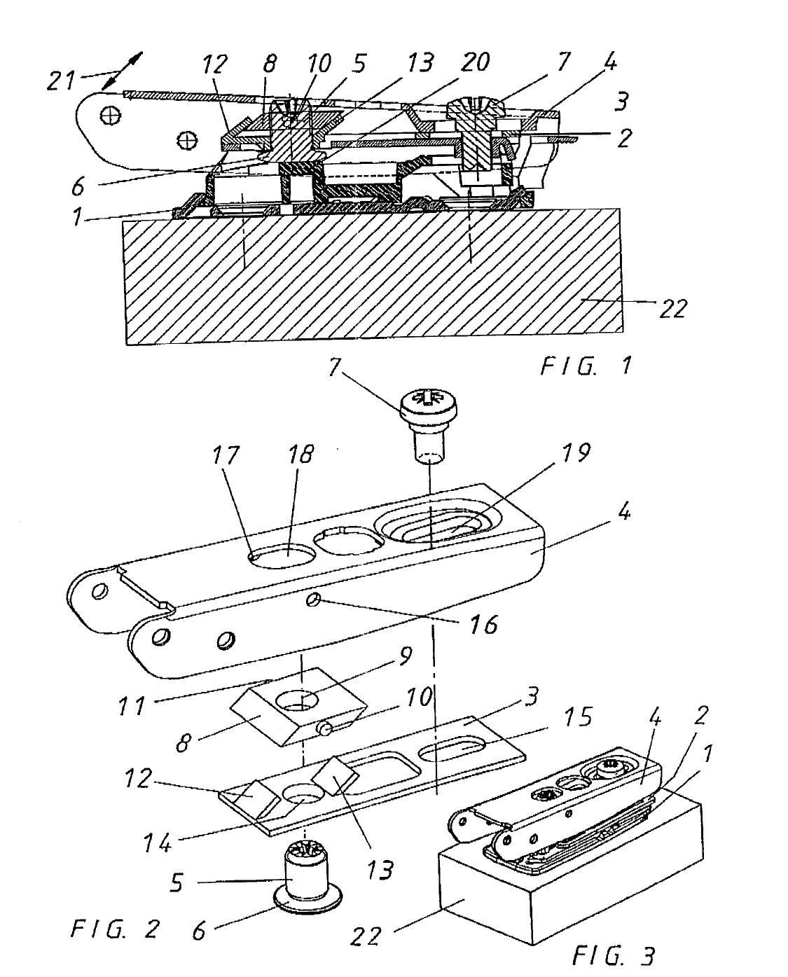

FIG. 2: an exploded representation of the hinge arm with the adjusting element and bearing plate;

FIG. 3: a perspective view of the hinge according to FIG. 1;

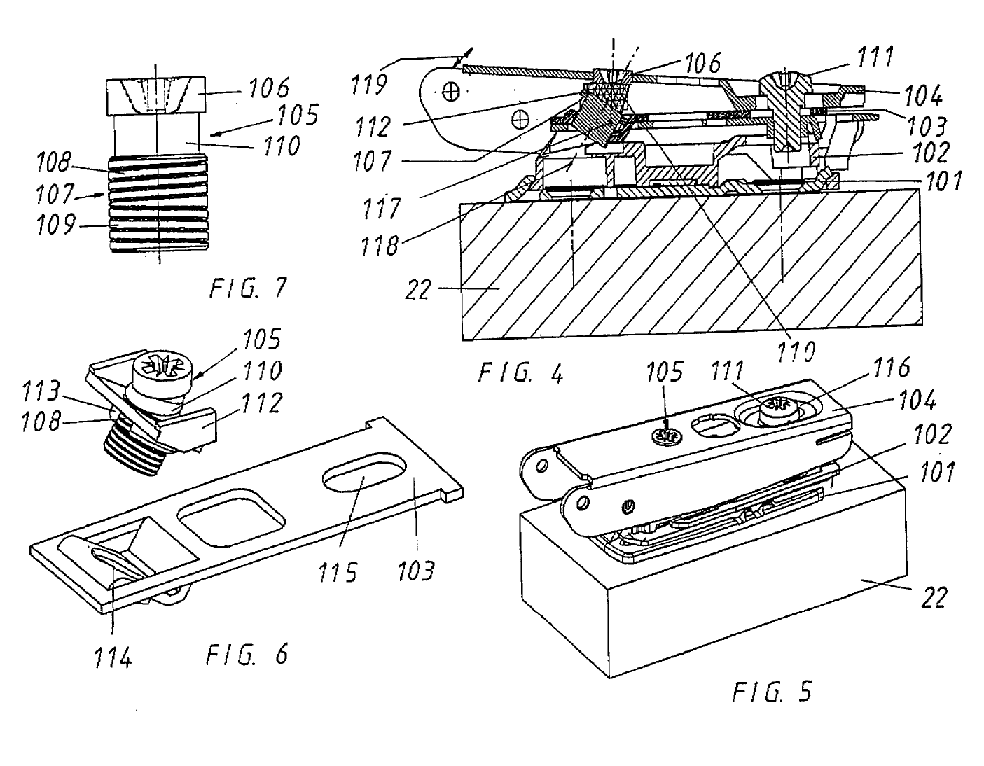

FIG. 4: a longitudinal section through a second embodiment of the invention-related cabinet hinge;

FIG. 5: a perspective view of the hinge according to FIG. 4;

FIG. 6: an exploded representation of the bearing plate with adjusting device according to FIG. 4;

FIG. 7: an enlarged view of the adjusting screw according to FIG. 6;

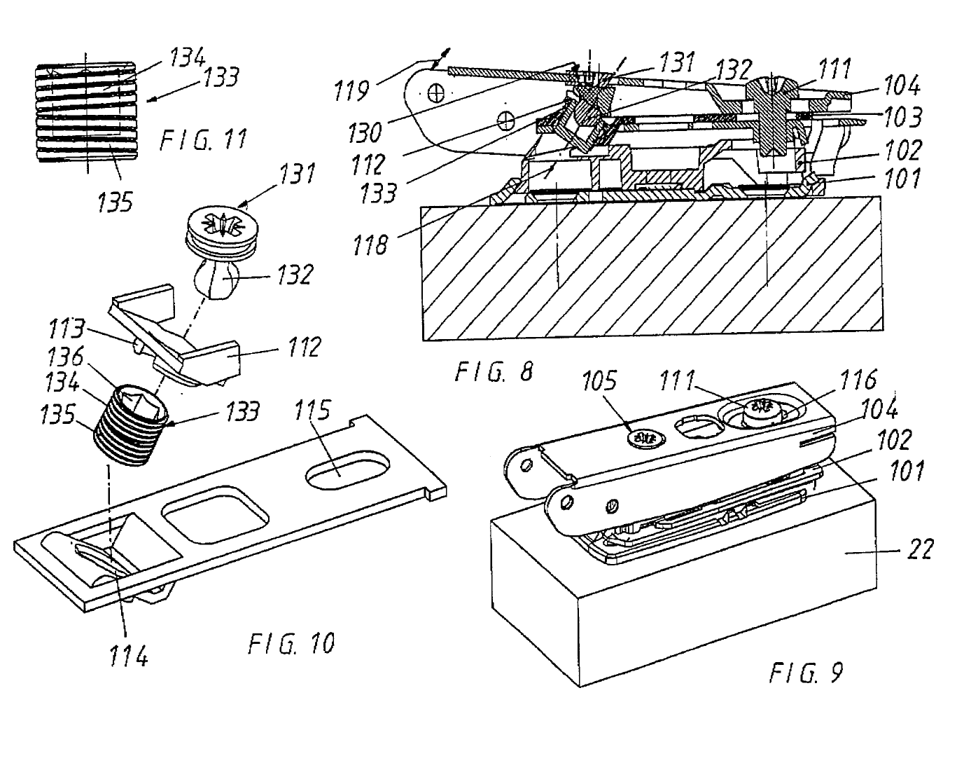

FIG. 8: a longitudinal section through a third embodiment of the invention-related cabinet hinge;

FIG. 9: a perspective view of the hinge according to FIG. 8;

FIG. 10: an exploded representation of the bearing plate with adjusting device according to FIG. 8;

FIG. 11: an enlarged view of the adjusting screw according to FIG. 10;

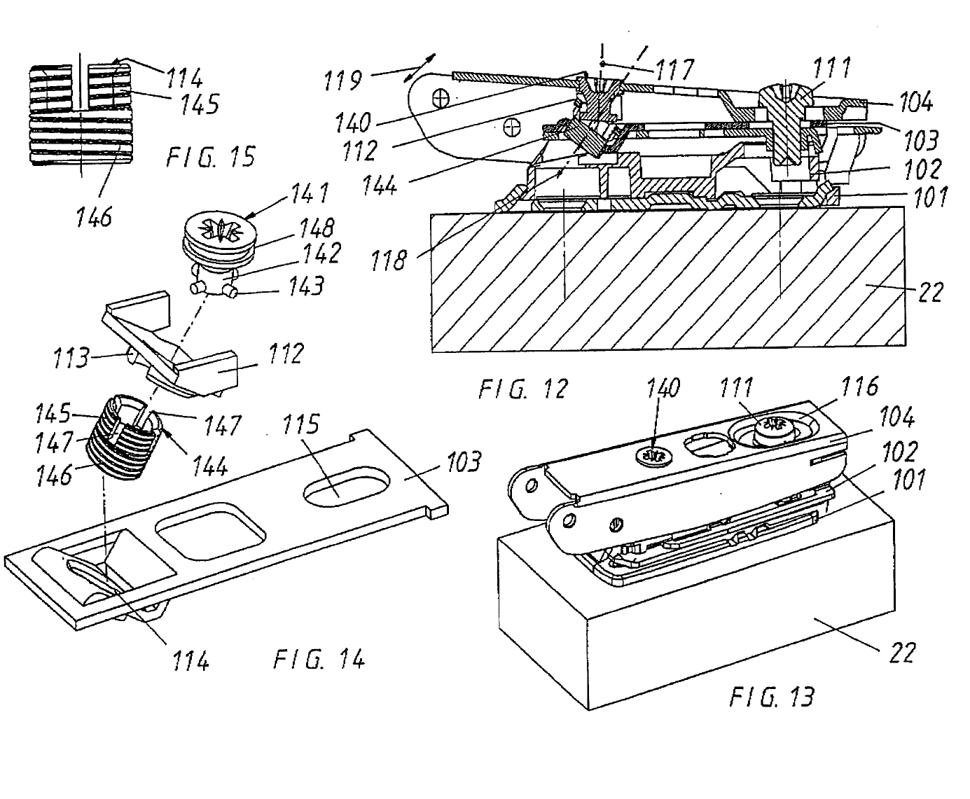

FIG. 12: a longitudinal section through a fourth embodiment of the invention-related cabinet hinge;

FIG. 13: a perspective view of the hinge according to FIG. 12;

FIG. 14: an exploded representation of the bearing plate with adjusting device according to FIG. 12;

FIG. 15: an enlarged view of the adjusting screw according to FIG. 14;

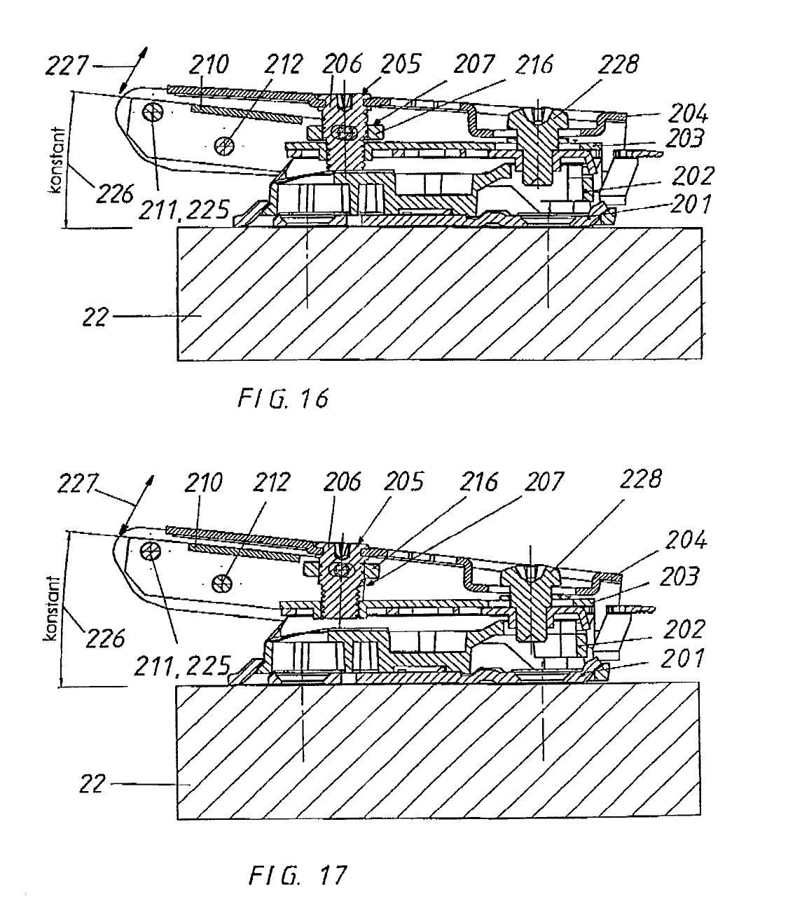

FIG. 16: a longitudinal section through a fifth embodiment of the invention-related cabinet hinge with a minimal side adjusting lift;

FIG. 17: a longitudinal section through a fifth embodiment of the invention-related cabinet hinge with a maximum side adjusting lift;

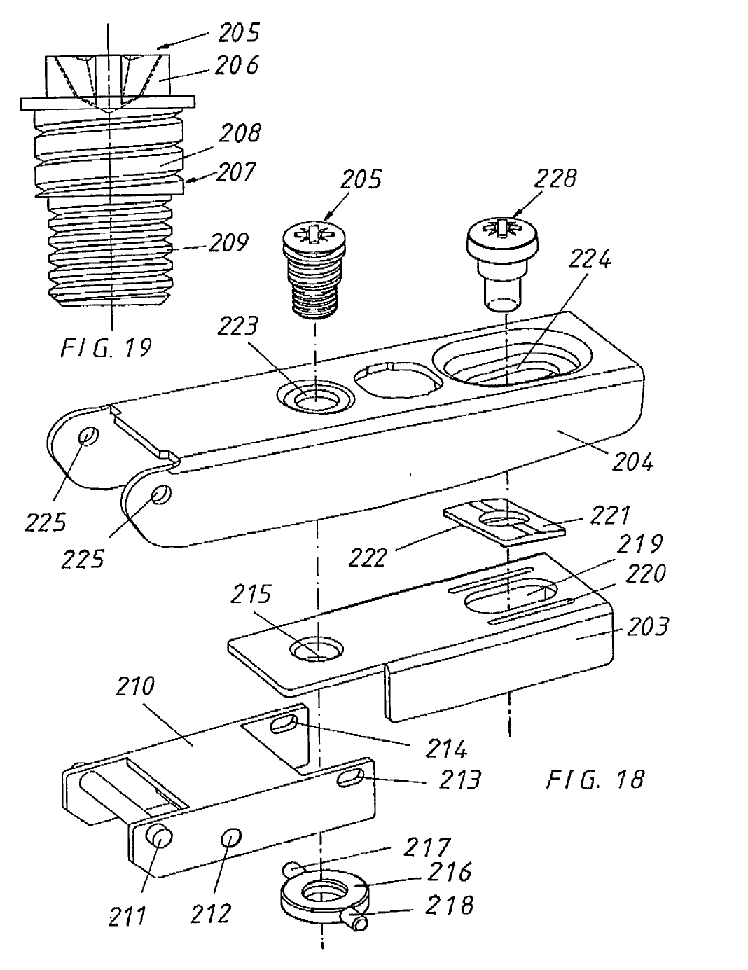

FIG. 18: an exploded representation of the hinge arm with adjusting device according to FIGS. 16 and 17;

FIG. 19: an enlarged view of the adjusting screw according to FIG. 18;

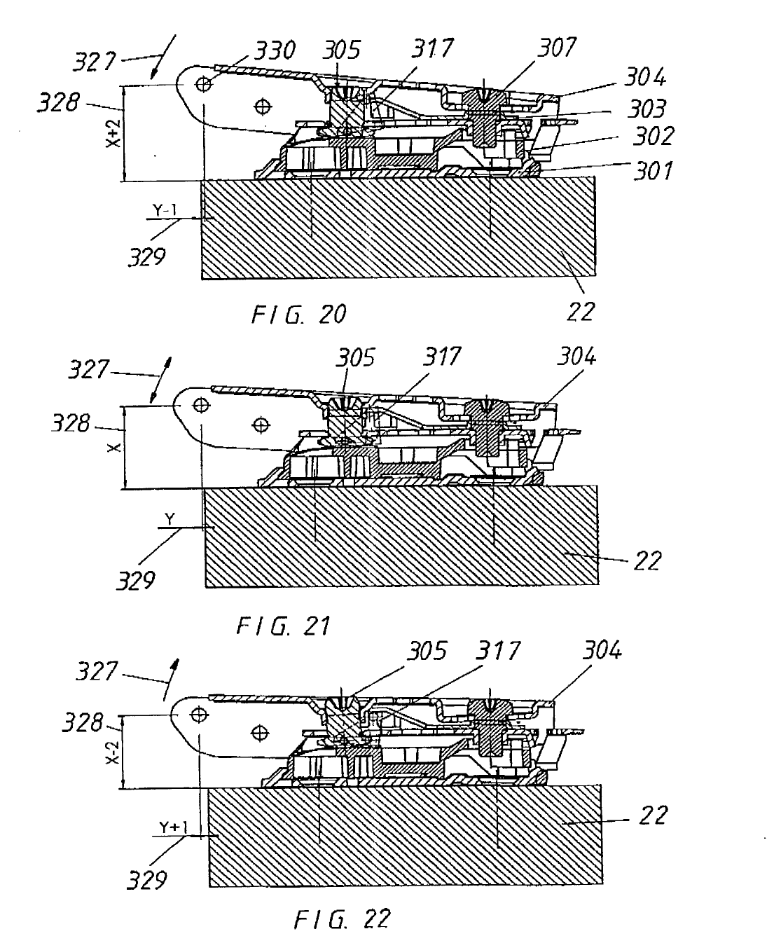

FIG. 20: a longitudinal section through a sixth embodiment of the invention-related cabinet hinge with maximum side adjusting lift;

FIG. 21: a longitudinal section through a sixth embodiment of the invention-related cabinet hinge in the basic (starting) position;

FIG. 22: a longitudinal section through a sixth embodiment of the invention-related cabinet hinge with minimal side adjusting lift;

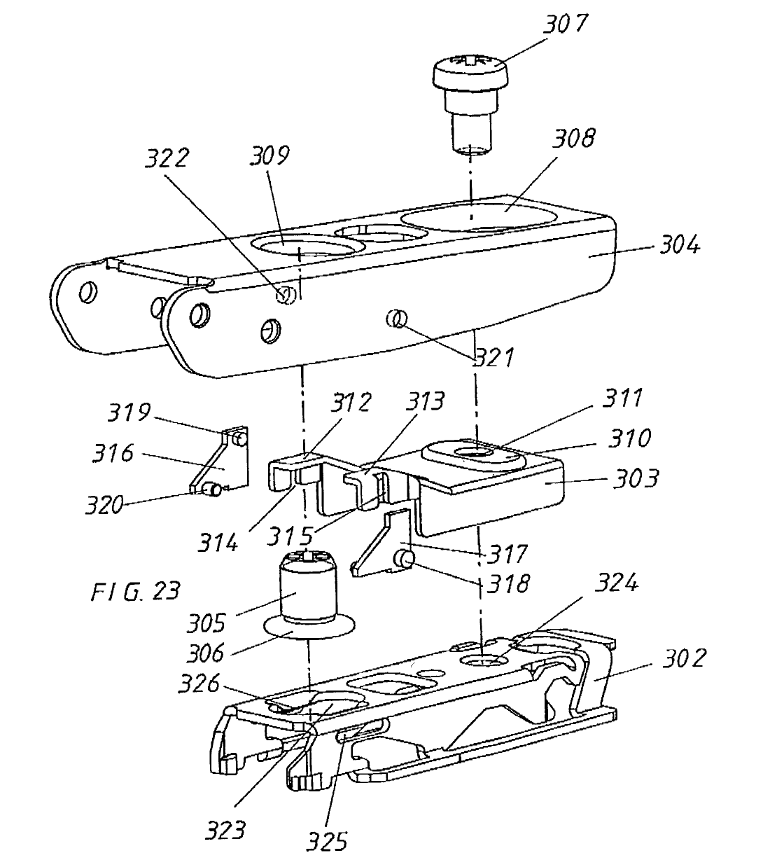

FIG. 23: an exploded representation of the hinge with adjusting device according to the FIGS. 20 to 22;

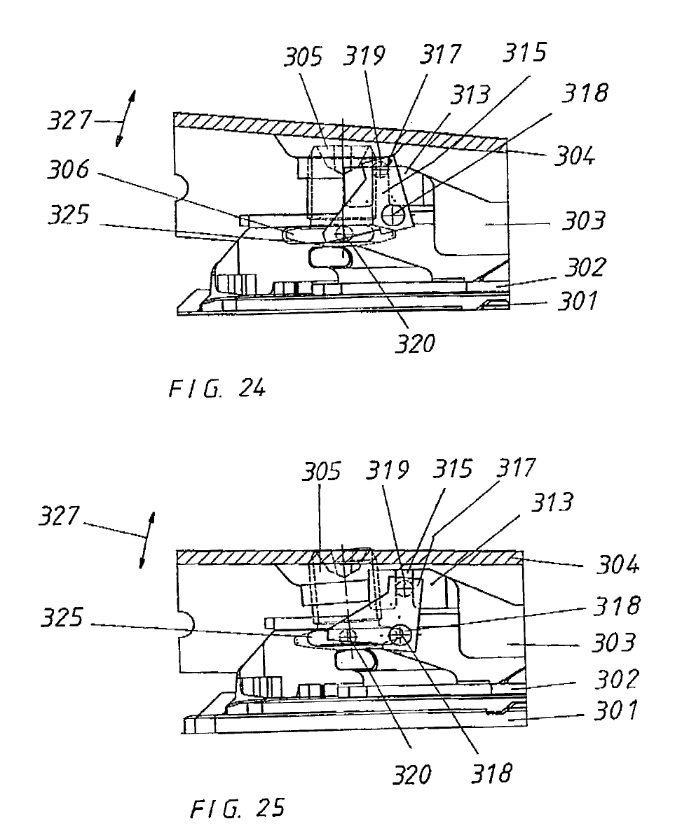

FIG. 24: a detailed view of the adjusting device with maximum side adjusting lift according to FIG. 20;

FIG. 25: a detailed view of the adjusting device with minimal side adjusting lift according to FIG. 22.

In all the shown embodiments of the invention, the cabinet hinge includes a mounting plate that consists of a baseplate (1; 101; 201; 301) and an adjusting plate (2; 102; 202; 302); whereby, the baseplate (1; 101; 201; 301) is fastened to the side wall of a cabinet component (22). The adjusting plate (2; 102; 202; 302) can be connected lockable and releasable to the baseplate (1; 101; 201; 301). A hinge arm (4; 104; 204; 304) is fastened on the adjusting plate (2; 102; 202; 302) by means of a bearing plate (3; 103; 203; 303). [The hinge arm] is connected jointed in a known manner with a door-side stop component (for example, a hinge cup [not shown] that is fixed in a cabinet door [not shown]). In order to laterally adjust the cabinet door (that is, adjusting the hinge arm [4; 104; 204; 304] in a direction perpendicular to the mounting level of the baseplate (1; 101; 201; 301), a side adjusting screw (5; 105; 205; 305) is provided.

The depth adjustment (that is, the adjustment of the hinge arm [4; 104; 204; 304) parallel to the baseplate (1; 101; 201; 301) is accomplished by means of a depth adjusting screw (7; 111; 228; 307), whose thread engages in a corresponding receptacle thread in the adjusting plate (2; 102; 202; 302). If the seat of the depth adjusting screw (7; 111; 228; 307) is somewhat loosened, the hinge arm (4; 104; 204; 304) can be moved along the adjusting plate (2; 102; 202; 302). By tightening the depth adjusting screw, the hinge arm is then fixed in the preset position.

If no special measure are taken, the hinge arm (4; 104; 204; 304) moves upward when the side adjusting screw (5; 105; 205; 305) is turned, so that the distance from the cabinet component (22) increases. Since the hinge arm (4; 104; 204; 304) does not cause a pure lifting motion with the side adjustment, but instead, a swinging movement, follows a circular motion around an imaginary axis with the center point somewhat in the area of the depth adjusting screw (7; 111; 228; 307) so that the adjustment takes place along a circular arc with a definite radius. So this not only results in an adjustment of the side gap width, but simultaneously, causes an increase of the gap between the front side of the cabinet component (22) and the cabinet door.

The invention works to prevent this undesired depth adjustment movement. The side adjusting screw (5), shown in FIGS. 1 to 3, is held with its thread in its thread bore hole (9) of an adjusting element (8), engages through an opening (14) of the bearing plate (3) and is supported with its screw head (6) on a corresponding bearing surface (20) of the adjusting plate (2).

The adjusting element (8) has two lateral pins (10, 11) that engage in corresponding bore holes (16, 17) in the side shanks of the hinge arm (4).

The bearing plate (3) includes two slanted guide brackets (12, 13) between which the adjusting element (8) is received.

The opening (18) in the hinge arm (4) gives one access to the side adjusting screw (5). By operating this screw, the adjusting element (8) moves together with the hinge arm (4) along the shaft of the screw (5), so that the adjusting movement of the hinge arm goes in arrow direction (21) because of the slanted guide brackets (12, 13), since respective gliding surfaces of the adjusting element (8) glides along these guide brackets (12, 13). This results automatically in the desired correction of the depth adjustment of the hinge arm when the side adjusting screw is operated. The depth adjusting screw (7) engages through an opening (19) in the hinge arm (4) as well as an opening (15) in the bearing plate (3) and is fixed in the adjusting plate (2).

FIGS. 4 to 7 show another embodiment of the side adjusting device. The bearing plate (103) includes a thread receptacle (114) pointed with an angle of 45° in the direction of the depth adjusting screw (111), into which the side adjusting screw (105) is inserted. As shown in FIG. 7, the side adjusting screw (105) includes a head section (106) as well as a thread section (107) so that the thread section includes an upper area (108) with right-hand thread and a lower area (109) with left-hand thread. The head section (106) is connected by an elastic separator piece (110) with the thread section (107). As is represented in FIG. 6, the upper thread section (108) is screwed into a thread bore hole (113) of an adjusting element (112) and the lower thread section (109) corresponds to the thread receptacle (114) of the bearing plate (103). According to FIG. 4 the screw's (105) head section (106) goes into an upper opening of the hinge arm (104). Thus, the axis (117) of the head section runs somewhat perpendicular to the mounting level of the bearing plate (103), against which the axis (118) of the thread section runs slanted to the mounting level of the bearing plate (103). The elastic separator piece (110) takes care of an elastic jointed or hinge connection between the head section (106) and the thread section (107). When the adjusting screw (105) is activated, the hinge arm is forced in arrow direction (119) (that is, along the axis [118] of the thread section [107]), so that not only a side adjustment of the corresponding cabinet door occurs, but also a correction of the depth adjustment in relation to the side adjustment.

Another embodiment of the side adjusting screw (130) is shown by FIGS. 8 to 11. The design of the hinge is identical to FIGS. 4 to 7, especially the embodiment of the bearing plate (103). The side adjusting screw (130) has a head section (131), as well as a thread section (133). The thread section is again divided; its upper area (134) has right-hand thread and the lower area (135) with left-hand thread, as shown in FIG. 11.

Furthermore, the thread section (133) has a hexagon receptacle (136), into which a corresponding bomb-shaped hexagon shaft (132) of the head section (131) engages. Due to the bomb-shaped design of the hexagon shaft (132), it is possible to activate the thread section (133) by the head section (131) in a certain angle range. In the assembled mounted state, the longitudinal middle axis (118) of the thread section runs somewhat slanted to the mounted level of the bearing plate (103) and the longitudinal middle axis (117) of the head section (131) runs perpendicular to the mounting level of the bearing plate (103). Operating the adjusting screw (130) on the head section (131) leads to an adjustment of the hinge arm (104) in arrow direction (119).

Another embodiment of a side adjusting screw (140) is shown in FIGS. 12 to 15. The side adjusting screw has a head section (141) and a thread section (144). The head section (141) includes a shaft (142) on which several pins (143) project radial outwardly. The thread section (144) includes again an upper section (145) with right-hand thread and a lower section (146) with left-hand thread. In addition, axial slots (147) are provided in the upper section (145). As shown especially in FIGS. 12 and 14, the pins (143) in the hinge's assembled state engage slanted in each of the corresponding slits (147) of the thread section (144) which allows the thread section to be operated. Consequently the longitudinal middle axes (117 and 118) of the head section (141), respectively the thread section (144), run into one another at an angle, so that an adjustment of the adjusting screw (114) results in a movement of the hinge arm in arrow direction (119). The head section (141) can have a bead (148) that stops it in a corresponding opening of the hinge arm (104).

Another embodiment of the invention is shown in FIGS. 16 to 19. The hinge includes, in a known manner, a baseplate (201) with a releasable fastened adjusting plate (202) on it, a bearing plate (203) and finally the hinge arm (204) that is connected with adjusting plate (202).

The side adjusting screw (205) is shown enlarged in FIG. 19. This includes a head section (206) and a thread section (207); whereby, the thread section is divided into an upper thread section (208) and a lower thread section (209). The adjusting screw (205) engages through an opening (223) in the hinge arm (204). The bottom thread section (209) of the screw (205) is inserted in a thread receptacle (215) of the bearing plate (203). On the upper thread section (208), there is an adjusting element (216) that has two opposite facing bearing pins (217, 218), which are held in corresponding elongated holes (213, 214) of a kinematic adapter (210). The front part of the kinematic adapter (210) includes bearings (211, 212) for the hinge's linkage bolts, so that the front linkage bolts engage through the kinematic adapter and, likewise, is held in the bearing (225) of the hinge arm (204). As a result of this, the kinematic adapter can swivel around the axis of the front bearing bolt (211). Shown in FIG. 16, the adjusting screw (205) can now be operated so that the lower screw section (209) goes upward in the thread receptacle (215) of the adjusting plate (203) and takes the hinge arm (204) with it upward in arrow direction (227) because the head section (206) is fastened to the screw (205) in the hinge arm. Simultaneously the adjusting element (216) goes upward on the upper thread section (208) and swivels the adjusting element connected to the kinematic adapter (210) likewise upward. The gradient of the thread section (208 and 209) are chosen so that an adjustment of the hinge arm in arrow direction (227) is accompanied by a rotating motion of the kinematic adapter (210); whereby, the angle (226) is defined, on the one hand, by the level of the cabinet component (22) and, on the other hand, by the upper edge of the kinematic adapter (210), that with an adjustment always remains constant as illustrated in FIG. 17. This means that operating the adjusting screw (205) activates a side adjustment, however, the kinematic of the hinge is altogether not changed. The depth adjusting screw (228) engages through an elongated hole (224) of the hinge arm (204), then further a bearing block (221), an elongated hole (219) in the bearing plate and is fastened in the adjusting plate (202). The bearing block (221) has guide ribs (222) that are held movable in corresponding guide slots (220) of the bearing plate (203). With this an adjusting movement of the hinge arm is possible in the longitudinal direction of the bearing plate (203). The bearing block (221) has a bomb-shaped upper bearing surface and operates as a swing bearing for the hinge arm (204) when this is swiveled by operating the front adjusting screw (205).

A final embodiment of the invention shows again a hinge, consisting of hinge elements (301 to 304) with a side adjusting screw (305) that inserts in a thread receptacle (309) of the hinge arm and whose screw head is supported on a corresponding surface of the adjusting plate (302).

FIG. 23 shows the interaction among the adjusting plate (302), the bearing plate (303) and the hinge arm (304). The bearing plate (303) sits on the adjusting plate (302) and has two lateral arms (312, 313). A vertical guide slot (314, 315) is located in each arm.

The adjusting plate (302) has in its area of the adjusting screw (305), two side horizontal guide lots (325 and 326) there, to be precise, where the adjusting screw (305) penetrates the opening (323) of the adjusting plate (302). Parallel to the side shanks of the hinge arm (304), there are opposite lying pivoted levers (316, 317). Each pivoted lever includes a bearing pin (318), that is held in a corresponding bore hole (321, 322) of the hinge arm (304). The pivoted lever (316, 317) has, furthermore, upper guide pins (319), which are guided in the guide slots (314, 315) of the bearing plate (303). Additionally, lower guide pins (320) are provided that are guided in the guide slots (325, 326) of the adjusting plate (302). By means of the pivoted levers (316, 317), a restricted guidance of the hinge arm (304) is achieved by operating the adjusting screw (305). This is illustrated section-wise in FIGS. 24 and 25. If the adjusting screw (305) is turned counterclockwise (starting at FIG. 24), the thread receptacle (309) of the hinge arm along the adjusting screw's thread is screwed downward so that the hinge arm moves downward in arrow direction 327. The final position is shown in FIG. 25. The screw head (306) works as a thrust bearing and lies always secure on the adjusting plate (302). Because of the pivoted levers (316, 317), the hinge arm (304) can, however, not move in any direction downward. Since the pivoted levers (316, 317) are connected securely by means of the bearing pin (318) to the hinge arm (304), an overriding movement that, on the one hand, by the guide slots (314, 315) and, on the other hand, by the guide slots (325, 326) are preset, because the corresponding guide pins (319, 320) of the pivoted lever (316, 317) are guided in these guide slots in a restrained and controlled manner. Because the adjusting plate (302) and the bearing plate (303) are fixed, the hinge arm (304) can only move by the pivoted levers (316, 317) in a preset direction. If one goes out of the neutral position, as shown in FIG. 21, the hinge arm moves upward in arrow direction (327) if the adjusting screw (305) is moved clockwise. In the way the distance (328) between the hinge arm and the cabinet component (22) increases, but the distance (329) between the front hinge axis (330) and the front edge of the cabinet component (22) decreases. This is shown in FIG. 20.

In a corresponding manner, when the screw (305) is turned counterclockwise, the hinge arm (304) moves downward so that the distance (328) decreases and the distance (329), however, increases. So when the side adjusting screw is operated, a corresponding correction of the depth adjustment takes place because of the restrained or controlled guidance of the hinge arm (304). This is illustrated in FIG. 22.

### Drawing Legend

| | | | |
|---|---|---|---|
| 1 | Baseplate | 105 | Adjusting screw |
| 2 | Adjusting plate | | (Side adjustment) |
| 3 | Bearing plate | 106 | Head section |
| 4 | Hinge arm | 107 | Thread section |
| 5 | Adjusting screw | 108 | Upper thread section |
| | (Side adjustment) | 109 | Lower thread section |
| 6 | Screw head | 110 | Elastic separator piece |
| 7 | Adjusting screw | 111 | Adjusting screw |
| | (Depth adjustment) | | (Depth adjustment) |
| 8 | Adjusting element | 112 | Adjusting element |
| 9 | Screw bore hole | 113 | Thread bore hole |
| 10 | Pin | 114 | Thread receptacle |
| 11 | Pin | | (Bearing plate) |
| 12 | Guide bracket (slant) | 115 | Opening (Bearing plate) |
| 13 | Guide bracket (slant) | 116 | Opening (Hinge arm) |
| 14 | Opening (bearing plate) | 117 | Axis |
| 15 | Opening (bearing plate) | 118 | Axis |
| 16 | Bore hole (hinge arm) | 119 | Arrow direction |
| 17 | Bore hole (hinge arm) | 120 | Arrow direction |
| 18 | Opening (hinge arm) | 130 | Adjusting screw |
| 19 | Opening (hinge arm) | 131 | Head section |
| 20 | Bearing surface | 132 | Hexagon shaft |
| | (adjusting plate) | 133 | Thread section |
| 21 | Arrow direction | 134 | Upper thread section |
| 22 | Cabinet component | 135 | Lower thread section |
| 101 | Baseplate | 136 | Hexagon receptacle |
| 102 | Adjusting plate | 220 | Guide slot |
| 103 | Bearing plate | 221 | Bearing block |
| 104 | Hinge arm | 222 | Guide ribs |
| 140 | Adjusting screw | 223 | Opening (hinge arm) |
| 141 | Head section | 224 | Opening (hinge arm) |
| 142 | Shaft | 225 | Bearing (linkage bolt & |
| 143 | Pin | | Hinge arm) |
| 144 | Thread part | 226 | Angle |
| 145 | Upper thread section | 227 | Arrow direction |
| 146 | Lower thread section | 228 | Adjusting screw |
| 147 | Slot | | (Depth adjustment) |
| 148 | Bead | 301 | Baseplate |
| 201 | Baseplate | 302 | Adjusting plate |
| 202 | Adjusting plate | 303 | Bearing plate |
| 203 | Bearing plate | 304 | Hinge arm |
| 204 | Hinge arm | 305 | Adjusting screw |
| 205 | Adjusting screw | | (Side adjustment) |
| | (Side adjustment) | 306 | Head section |
| 206 | Head section | 307 | Adjusting screw |
| 207 | Thread part | | (Depth adjustment) |
| 208 | Upper thread part | 308 | Opening (hinge arm) |
| 209 | Lower thread part | 309 | Thread receptacle |
| 210 | Kinematic adapter | | (Hinge arm) |
| 211 | Bearing (linkage bolt) | 310 | Bearing block |
| 212 | Bearing (linkage bolt) | 311 | Opening (bearing block) |
| 213 | Elongated hole | 312 | Arm |
| 214 | Elongated hole | 313 | Arm |
| 215 | Thread receptacle | 314 | Guide slot |
| | (Bearing plate) | 315 | Guide slot |
| 216 | Adjusting element | 316 | Pivoted lever |
| 217 | Bearing pin | 317 | Pivoted lever |
| 218 | Bearing pin | | |
| 219 | Opening | | |
| | (bearing plate) | | |
| 318 | Bearing pin | | |
| 319 | Guide pin | | |
| 320 | Guide pin | | |
| 321 | Bearing bore hole | | |
| 322 | Bearing bore hole | | |
| 323 | Opening | | |
| 324 | Opening | | |
| 325 | Guide slot | | |
| 326 | Guide slot | | |
| 327 | Arrow direction | | |
| 328 | Distance | | |
| 329 | Distance | | |

1. Cabinet hinge with side adjusting device that connects directly or indirectly on a cabinet-side, has a single- or multi-part baseplate (1) holding a hinge arm (4) is connected jointed or linked or hinged with a door-side stop component so that by means of the side adjusting device, the hinge arm's (4) position can be changed perpendicular to the baseplate (1) and, at the same time, results in a correction of the depth adjustment of the hinge arm is characterized by the side adjusting device that has a hinge arm (4) connected to the adjusting element (8), which is guided movable by the guide brackets (12, 13) on a bearing plate (3), that is engaged by a side adjusting screw (5) and, when the side adjusting screw is operated, moves with the hinge arm (4) parallel to the guide brackets (12, 13).

2. Cabinet hinge, according to claim 1, is characterized by the guide brackets (12, 13) that project up slanted from the upper surface of the bearing plate (3) and receive the adjusting element (8) between them.

3. Cabinet hinge, according to one of the claims 1 or 2, is characterized by the adjusting element (8), which is formed basically prism-shaped and includes two slanted gliding surfaces that are parallel to each other and always fit on a corresponding guide bracket (12, 13).

4. Cabinet hinge, according to one of the claims 1 to 3, is characterized by the adjusting element (8) that has two lateral pins (10, 11) that are located opposite each other and are held in corresponding bore holes (16, 17) of the hinge arm's (4) side shanks.

5. Cabinet hinge with side adjusting device connects directly or indirectly on a cabinet-side, has a single- or multi-part baseplate (101) that holds a hinge arm (104) that is connected jointed or hinged with a door-side stop component; whereby, by means of the side adjusting device, the hinge arm's (104) position can be chanted perpendicular to the baseplate (101) and, at the same time, results in a correction of the hinge arm's depth adjustment is characterized by the side adjusting device is held in a bearing plate (103) and the side adjusting screw (105; 130; 140) with a head section (106; 131; 141) and a thread section (107; 133; 144) is connected directly or indirectly with the hinge arm (104); whereby, the longitudinal middle axis (118) of the thread section (107; 133; 144) that forms an angle level to the bearing plate and operating the side adjusting screw (105; 130; 140) causes the hinge arm (104) to slide along the longitudinal middle axis (118) of the thread section (107; 133; 144).

6. Cabinet hinge, according to claim 5, is characterized by the head section (106; 131; 141) is connected elastic or jointed or hinged with the thread section (107; 133; 144) so that the middle longitudinal axis (117; 118) or the head section and the thread section go differently.

7. Cabinet hinge, according to one of the claims 5 or 6, is characterized by the thread section (107; 133; 144) that has left-hand thread in its lower section (109; 135; 146) and right-hand thread in its upper section (108; 134; 145) so that the lower section of the thread receptacle (114) engages the bearing plate (103) and the upper section of the thread receptacle (113) engages an adjusting element (112).

8. Cabinet hinge, according to one of the claims 5 to 7, is characterized by the adjusting element (112) that is connected securely to the hinge arm (104).

9. Cabinet hinge, according to one of the claims 5 to 8, is characterized by the head section (106) that is connected by an elastic separator piece (110) to the thread section (107).

10. Cabinet hinge, according to one of the claims 5 to 8, is characterized by the head section (131) that has a bomb-shaped hexagon shaft (132) in the lower area; which [the bomb-shaped hexagon shaft] engages in a hexagon opening (136) of the thread section (133).

11. Cabinet hinge, according to one of the claims 5 to 8, is characterized by the head section (141) that has a shaft (142) which has several pins (143) distributed around the perimeter; [the pins] engage laterally into slots (147) distributed around the perimeter of the thread section (144).

12. Cabinet hinge, according to one of the claims 5 to 11, is characterized by the head section (106; 131; 141) that is secured revolvable in an opening of the hinge arm (104).

13. Cabinet hinge with side adjusting device connecting directly or indirectly on a cabinet side, has a single- or multi-part baseplate (201) that holds a hinge arm (204), that is connected jointed or hinged with a door-side stop component; whereby, by means of the side adjusting device, the position of the hinge arm (204) can be changed perpendicular to the baseplate (291) and, at the same time, results in a correction of the depth adjustment of the hinge arm is characterized by the side adjusting device that includes a side adjusting screw (205) with a lower thread section (209) and an upper thread section (208), so that the lower thread section (209) engages in a thread receptacle (215) of the bearing plate (203) and the upper thread section (208) engages in a movable adjusting element (216) along the thread section (208), that connects with a kinematic adapter (210) that is held, able to swivel, on a link bolt (211) of the hinge arm (204) and swings or swivels around an axis (225) in relation to the position of the adjusting element (216).

14. Cabinet hinge, according to claim 13, is characterized by the kinematic adapter (210) that swings or swivels when the side adjusting screw (205) is operated and that the angle (226) formed from the middle longitudinal axis of the baseplate (201) and the kinematic adapter (210) remains constant.

15. Cabinet hinge, according to one of the claims 13 or 14, is characterized by the thread sections (208, 209) that have various gradients or pitches.

16. Cabinet hinge, according to one of the claims 13 to 15, is characterized by the adjusting element (216) that is formed ring-shaped and has two pins (217, 218) that lie opposite each other and are held movable in corresponding elongated holes (213, 214) of the kinematic adapter (210).

17. Cabinet hinge, according to one of the claims 13 to 16, is characterized by a bomb-shaped bearing block (221) that is provided between the hinge arm (204) and the bearing plate (203) in a distance from the side adjusting screw (205).

18. Cabinet hinge, according to one of the claims 13 to 16, is characterized by the bearing block (221) that is located linear movable on the bearing plate (203).

19. Cabinet hinge with side adjusting device connecting directly or indirectly on a cabinet side, has a single- or multi-part baseplate (301) that holds a hinge arm (304), that is connected jointed or hinged or linked with a door-side stop component; whereby, by means of the side adjusting device, the position of the hinge arm (304) can be changed perpendicular to the baseplate (301) and, at the same time, results in a correction of the depth adjustment of the hinge arm is characterized by that the side adjusting device includes pivoted levers (316, 317), which are held revolvable on the hinge arm (304) and whose lever arms on or in opposite to the baseplate's (301) fixed part of the hinge are guided, so when the side adjusting screw (305) is operated, a restrained and controlled guidance of the hinge arm (304) is provided.

20. Cabinet hinge, according to claim 19, is characterized by the fixed components that are the adjusting plate (302) and a bearing plate (303).

21. Cabinet hinge, according to one of the claims 19 or 20, is characterized by the guide pins (319, 320) on the lever arm on the pivoted lever (316, 317), that, are guided on the on hand, by linear guides (325, 326) of the adjusting plate (302) and, on the other hand, by linear guides (314, 315) of the bearing plate (303) and, there is always a bearing pin (318) that is held revolvable in a bore hole (321, 322) of the hinge arm (304).

22. Cabinet hinge, according to one of the claims 19 to 21, is characterized by the pivoted levers (316, 317) in the hinge arm (304) that are basically parallel to its side shanks.

23. Cabinet hinge, according to one of the claims 19 through 22, is characterized by the guides (325, 326) of the adjusting plate (302) and the guides (314, 315) of the bearing plate (303) that run together at an angle.
